(19) United States
(12) Patent Application Publication
(10) Pub. No.: US 2015/0053841 A1
(43) Pub. Date: Feb. 26, 2015

(54) BEARING MECHANISM FOR MOVABLE BODY

(71) Applicants: Huizhou Dayawan Ever Bright Electronic Industry Co., Ltd., Huizhou (CN); JSS Optical Technology Co., Ltd., HONG KONG (HK); Huizhou Daya Bay Jss Optical Technology.Co., Ltd., Huizhou (CN)

(72) Inventor: Kokichi Terajima, Tokyo (JP)

(21) Appl. No.: 14/463,873

(22) Filed: Aug. 20, 2014

(30) Foreign Application Priority Data
Aug. 23, 2013 (JP) 2013-173483

(51) Int. Cl. G02B 27/64; F16M 11/04; F16M 13/00

(52) U.S. Cl. CPC G02B 27/646; F16M 13/00; F16M 11/04
USPC 248/638

(57) ABSTRACT

The present invention provides a bearing mechanism for a movable body capable of moving in parallel successfully and accurately without causing rotation. An outside fixed link (101a) of a +Y side compound link (128a) formed by serially connecting an outside parallel link (128c) with an inside parallel link (128d) is connected with a fixed frame (129), an outside fixed link (101b) of a −Y side compound link (128b) formed by serially connecting an outside parallel link (128e) with an inside parallel link (128f) is connected with the fixed frame (129), an inside output link (113a) of the +Y side compound link (128a) is connected with a movable body connecting component (121) from the +Y side, and an inside output link (113b) of a −Y side compound link (128b) is connected with the movable body connecting component (121) from the −Y side.

### CROSS-REFERENCE TO RELATED APPLICATIONS

None.

### BACKGROUND OF THE INVENTION

1. Field of the Invention

The present invention relates to a bearing mechanism for a movable body, in particular to a bearing mechanism for a camera lens and a lens driving device and the like, needing to be moved accurately and movably.

2. Description of Related Art

In recent years, a portable telephone with various functions, particularly a portable telephone provided with a camera is widely popularized. Besides an auto focus function, the camera installed in the portable telephone is also seeking for a hand shaking correction function and the like through updating.

A hand shaking correction device 310 as shown in FIG. 14A and FIG. 14B is one of examples. The hand shaking correction device 310 adopts a wire suspension manner, so that the lens driving device 300 with the auto focus function can be assembled in the camera in a swinging manner. Namely, the hand shaking correction device 310 realizes focusing by enabling the lens 305 to move along the direction of an optical axis (the O axis direction), and the lens 305 is enabled to swing together with the lens driving device 300 along the directions of P axis and Q axis which are orthogonal to the O axis direction and are orthogonal to each other, thus hand shaking correction is realized.

The hand shaking correction device 310 as shown in FIG. 14A and FIG. 14B comprises: four suspension wires 302, a permanent magnet 304 and coils 303P and 303Q for hand shaking correction. One ends of the four suspension wires 302 are fixed at four corners of a substrate 301; the permanent magnet 304 is installed on the lens driving device 300; and the coils 303P and 303Q for hand shaking correction are configured on the outside of the permanent magnet 304 and arranged opposite to the permanent magnet 304.

The four suspension wires 302 extend along the O axis direction, and the other ends of the four suspension wires 302 are fixed on the upper end side of the lens driving device 300. Therefore, the four suspension wires 302 are used for supporting the lens driving device 300 so that the lens driving device 300 can swing along the directions of P axis and Q axis respectively.

As shown in FIG. 14B, the lens driving device 300 comprises: a lens support 307, a non-graphical coil for auto focus, a magnet support 308 and two leaf springs 306. The lens support 307 is used for retaining the lens; the coil for auto focus is wound on the periphery of the lens support 307; the magnet support 308 is arranged opposite to the coil for auto focus at an interval, and is used for retaining the permanent magnet 304 configured on the outer diameter side of the coil for auto focus; and the two leaf springs 306 are respectively arranged in front and at the back of the lens support 307 in the O axis direction. Bent wrist parts 306a are respectively arranged at the four corners of the two leaf springs 306 one by one. The wrist parts 306a are used for supporting the lens support 307 to be positioned in the radial direction (the directions of P axis and Q axis), and to be capable of move along the O axis direction. Namely, the lens driving device 300 as shown in FIG. 14B is a lens driving device in a leaf spring suspension manner.

In order to focusing a shot object by the hand shaking correction device 310, the lens 305 is enabled to move in proper position towards the O axis direction driven the lens driving device 300, and the moving is counteracted with the shaking of a telephone shell of the portable telephone with the camera. In order to correct the hand shaking, the whole lens driving device 300 is enabled to swing in the directions of P axis and Q axis.

Namely, when the coil for auto focus is electrified, the lens driving device 300 generates a Lorentz force on the coil for auto focus in the O axis direction, thus the lens support 307 can move in the O axis direction at the position balanced with resilience of the eight wrist parts 306a of the leaf springs 306. Moreover, when the coil 303Q for hand shaking correction configured opposite to the permanent magnet 304 along the direction of P axis is electrified, the hand shaking correction device 310 enable the lens driving device 300 to swing in the Q axis direction; when the coil 303Q for hand shaking correction configured opposite to the permanent magnet 304 along the direction of Q axis, the lens driving device 300 can be enabled to swing in the direction of P axis (e.g. by reference to patent documentation 1: JP Patent 2011-65140).

Moreover, the lens driving device 400 as shown in FIG. 15 is a lens driving device in an axis sliding manner, and comprises a base plate 403, a cover 404, a cylindrical lens support 402, two guiding shafts 405A and 405B, a ring-shaped permanent magnet 406 for auto focus, a ring-shaped coil 408 for auto focus and a double cylinder-shaped magnet yoke 407. The cylindrical lens support 402 is used for retaining the lens 401; the two guiding shafts 405A and 405B are respectively fixed on the base plate 403 and the cover 404 and are used for guiding the lens support 402 in the direction of the optical axis (the O axis direction); the ring-shaped permanent magnet 406 for auto focus is arranged on the lens support 402; the ring-shaped coil 408 for auto focus and the double cylinder-shaped magnet yoke 407 are arranged on the cover 404. The lens support 402 is supported by the guiding shafts 405A and 405B.

Namely, the two ends of the guiding shafts 405A and 405B extending along the O axis direction are respectively embedded and fixed on the base plate 403 and the cover 404, so that the lens support 402 can be freely embedded in the guiding shafts 405A and 405B in a sliding manner relative to the guiding shafts 405A and 405B, and can be movably installed along the O axis direction.

The permanent magnet 406 for auto focus is fixed on the periphery of a cylindrical part of the lens support 402. The coil 408 for auto focus is fastened on the cover 404 through the magnet yoke 407, and the outer peripheral surface of the permanent magnet 406 for auto focus and the inner peripheral surface of the coil 408 for auto focus are arranged opposite to each other at an interval along the radial direction.

The magnet yoke 407 is installed on the cover 404, and is formed to into a double cylinder-shape with a U-shaped cross section. Moreover, an inner cylindrical part of the magnet yoke 407 is inserted between the permanent magnet 406 for auto focus and the lens support 402 in a non-contact manner. The magnet yoke 407 is used for retaining the coil 408 for auto focus by utilizing the inner peripheral surface of an outer cylindrical part.

A spiral spring 409 is configured around the guiding shaft 405A at a state of compression. One end of the spiral spring 409 abuts against the back side of the cover 404 (by taking the positive direction of O axis as datum), and the other end of the spiral spring 409 abuts against the front end of the lens support 402 in the O axis direction, thus the spiral spring 409 is installed and the lens support 402 receives a spring force towards the direction of the back of O axis.

According to the lens driving device 400, when the coil 408 for auto focus is electrified, the Lorentz force is generated towards the direction of the front of O axis, and the lens support 402 can be enabled to slide along the extension directions of the guiding shafts 405A and 405B to the position that the spring force of the spiral spring 409 is balanced to the Lorentz force (e.g. by reference to patent documentation 2: JP Patent 2008-185749).

However, as the hand shaking correction device 310 shown in FIG. 14A, according to the direction of hand shaking, the lens driving device 300 is enabled to move in parallel along an approximate direction which is orthogonal to the direction of the optical axis, but the four suspension wires 302 are likely to be bent or twisted along individual direction respectively. Therefore, the supported lens driving device 300 rotates by taking O1 axis parallel to the O axis at any position as a center, thus the lens 305 is likely to rotate at an eccentric state. Therefore, the hand shaking correction device 310 enables the lens driving device 300 to move in the direction based on hand shaking, and the lens 305 rotates at the eccentric state, so that image shift is possibly caused.

Moreover, the lens driving device 300 mounted in the hand shaking correction 310 adopts the leaf spring suspension manner, thus the lens support 307 is suspended by the eight wrist parts 406a and runs at a floating state towards the O axis direction from the magnet support 308. However, the machining sizes of the eight wrist parts 306a of the lens driving device 300 possibly have deviation, or the installation site of the coil for auto focus has deviation, so that the magnetic field that the permanent magnet 304 acts on the coil for auto focus cause non-uniformity. Under such condition, the center of the restoring force generated by the eight wrist parts 306a is deviated from the center of the Lorentz force generated by the coil for auto focus mutually, so that a torque is generated around a T axis orthogonal to the optical axis as shown in FIG. 14B in any direction, which causes a tilt phenomenon of the lens support 307 rotating around the T axis and the problem that the image is distorted.

Moreover, the lens driving device 400 as shown in FIG. 15 enables the lens support 402 to slide along the extension directions of the guiding shafts 405A and 405B, thus the tilt phenomenon caused by rotation of the lens support 307 of the lens driving device 300 in the leaf spring suspension manner around the axis orthogonal to the optical axis as shown in FIG. 14 is prevented. However, during operation, the lens support 402 rubs against the embedded parts of the guiding shafts 405A and 405B to cause that the lens support 402 is difficult to move successfully. Namely, a propulsive force capable of overcoming the static frictional force needs to be applied to the lens support 402 when the lens support 402 begins to move, thus a heavy current capable of overcoming the static frictional force is required to be delivered to the coil 408 for auto focus. However, the frictional force during moving is reduced, but the amount of electric current when the lens support 402 begins to move still kept all the time may cause excess propulsive force, so that the lens support 402 is likely to exceed a predetermined stop position so as to over running and the problem that the lens support 402 is difficult to accurately locate occurs.

As mentioned above, the hand shaking correction device 310 provided with the lens driving device 300 which is supported by the suspension wires 302 in a wire suspension manner has the problem of rotation around axes parallel to the optical axis. Moreover, the lens driving device 300 in the leaf spring suspension manner can enable the lens support 307 to move successfully, but the problem that the lens support 307 is tilted to cause that the lens support 307 is easily tilted relative to the optical axis appears. And then, in the lens driving device 400 in the axis sliding manner, the lens support 402 is unlikely to tilt, but the problem that the lens support 402 is unlikely to locate accurately since the lens support 402 is difficult to move successfully appears.

### BRIEF SUMMARY OF THE INVENTION

In view of the existing problems, the present invention aims to provide a bearing mechanism for a movable body, wherein the bearing mechanism is capable of moving successfully and accurately without generating friction, and the tilt phenomenon caused by rotation cannot occur.

A bearing mechanism for a movable body provided with at least one pair compound links in an XYZ three-dimensional orthogonal coordinate system. Each compound link includes an outside parallel link and an inside parallel link. The outside parallel link includes an outside fixed link, an outside output link and a first to a M-th outside active links connected between the outside fixed link and the outside output link via a plurality of joint axles extended along a Z axis direction respectively. The first to the M-th outside active links are configured parallel from a +X side to a −X side, and the M refers to an integer more than 2. The inside parallel link includes an inside fixed link, an inside output link and a first to an N-th inside active links connected between the inside fixed link and the inside output link via a plurality of joint axles extended along the Z axis direction respectively. The first to the N-th inside active links are configured parallel from the +X side to the −X side, and the N refers to an integer more than 2. The outside parallel link is mutually connected with the inside parallel link through the outside output link and the inside fixed link, so that the at least two compound links are configured opposite to each other on a +Y side and on a −Y side relative to the inside output link.

Thus, the manufactured bearing mechanism for keeping balance of the movable body is used for connecting with the movable body in parallel along the +Y side and the −Y side by the compound links formed by serially connecting the parallel links. Therefore, the movable body receiving the bearing cannot rotate around the axis parallel to the Z axis, and the movable body cannot rotate and tilt around the axis forming a right angle with the Z axis even if receiving the force in the Z axis direction. Thus, the movable body can be born to move accurately in the X axis direction and Y axis direction in parallel.

Moreover, as a preferable embodiment of the present invention, in the at least two compound links, an outward normal line of a plane formed by joint axles configured on the two sides of the first outside active link tilts by an acute angle from the +X axis to any of the +Y side and the −Y side, and an outward normal line of a plane formed by joint axles configured on the two sides of the first inside active link tilts by an acute angle from the +X axis to the other of the +Y side and the −Y side.

Thus, the rotatable orientation of the first to the M-th outside active links and the rotatable orientation of the first to the N-th inside active links are mutually opposite, thus integral rotatable orientation of the rotatable orientation of the first to the M-th outside active links and the rotatable orientation of the first to the N-th inside active links are enlarged, and therefore the movable range of the connected movable body can be increased.

Moreover, as another preferable embodiment of the present invention, the outside output link configured at the +Y side, a restricted link, and the outside output link configured at the −Y side are serially connected with one another through a plurality of joint axles prolonged along the Z axis direction.

Therefore, when the +Y side outside output link and the −Y side outside output link are serially connected with the restricted links through the joint axles prolonged along the Z axis direction mutually, so that the change of the interval between the +Y side outside output link and the −Y side outside output link is restricted, as a result, the movements of the +Y side outside output link and the −Y side outside output link towards the X axis direction are restricted, so that the movable body cannot rotate, thus the inside output link and the outside output link can be supported to move stably just in the Y axis direction in parallel.

Moreover, the summary of the invention does not list all features required by the present invention, and auxiliary combination of these features can also become the present invention.

### BRIEF DESCRIPTION OF THE SEVERAL VIEWS OF THE DRAWING(S)

The foregoing and other exemplary purposes, aspects and advantages of the present invention will be better understood in principle from the following detailed description of one or more exemplary embodiments of the invention with reference to the drawings, in which:

FIG. 1 is a perspective view of a bearing mechanism in according to a first embodiment of the present invention;

FIG. 2 is a perspective view of a compound link in the bearing mechanism in according to the first embodiment;

FIG. 3 is a diagrammatic figure for describing an action of the bearing mechanism in according to the first embodiment;

FIG. 4 is a perspective view of another compound link in the bearing mechanism in according to the first embodiment;

FIG. 5 is a perspective view of yet another compound link in the bearing mechanism in according to the first embodiment;

FIG. 6A and FIG. 6B are a perspective view and an exploded view of further another compound link in the bearing mechanism in according to the first embodiment;

FIG. 7 is a perspective view of a hand shaking correction device using the bearing mechanism of the first embodiment;

FIG. 8 is a perspective view of another hand shaking correction device using the bearing mechanism of the first embodiment;

FIG. 9A and FIG. 9B are perspective views of yet another hand shaking correction device using the bearing mechanism of the first embodiment;

FIG. 10 is a perspective view of the bearing mechanism in according to a second embodiment of the present invention;

FIG. 11 is a diagrammatic figure for describing a action of the bearing mechanism in according to the second embodiment;

FIG. 12 is a curve chart for describing the performance of the bearing mechanism in according to the second embodiment;

FIG. 13A and FIG. 13B are a perspective view and an exploded view of a lens driving device using the bearing mechanism of the second embodiment;

FIG. 14A and FIG. 14B are diagrams illustrating a hand shaking correction device provided with an existing bearing mechanism; and

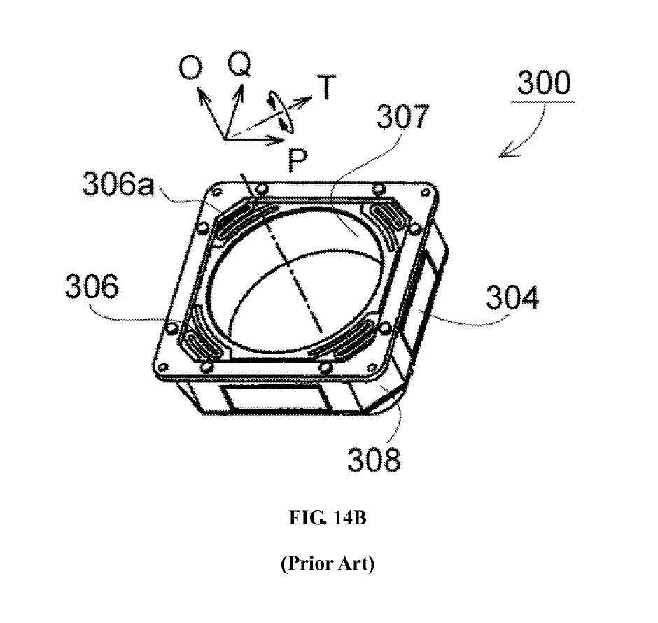

FIG. 15 is a diagram illustrating a lens driving device provided with the existing bearing mechanism.

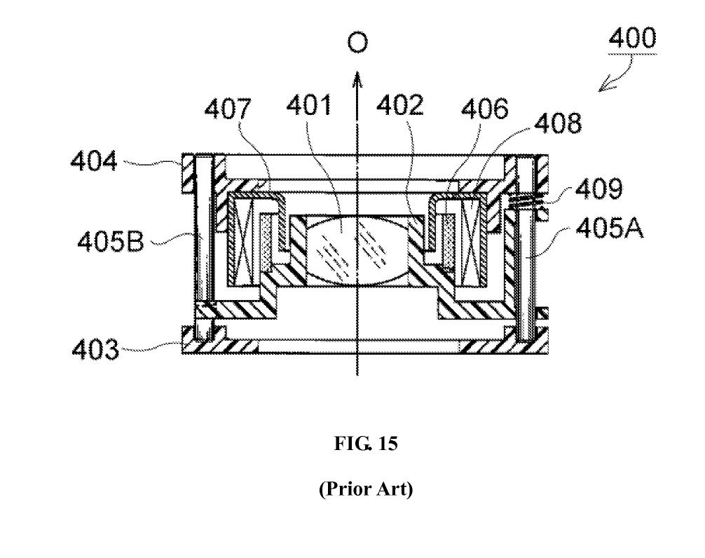

### DETAILED DESCRIPTION OF THE INVENTION

The invention will now be described in detail through several embodiments with reference to the accompanying drawings, but the following embodiments do not limit claims of the present invention, and the combination of all features described in the embodiments does not necessary for solutions of the present invention.

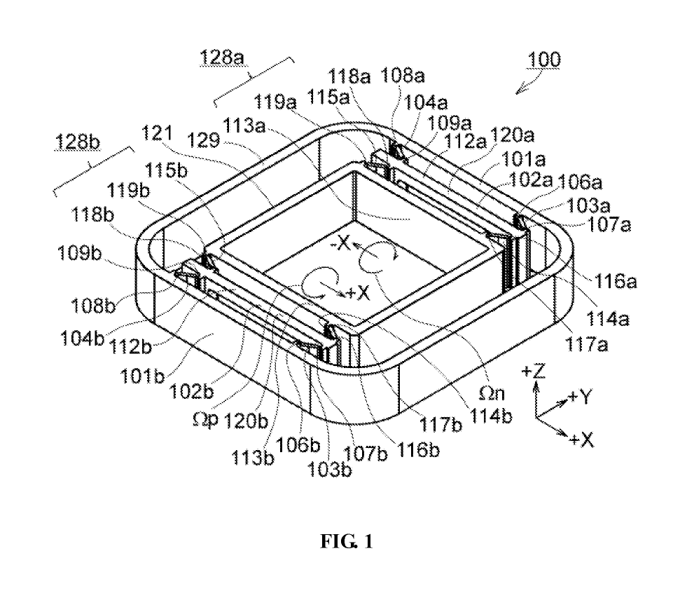

FIG. 1 is a perspective view of a bearing mechanism in according to a first embodiment of the present invention. The bearing mechanism 100 includes: a +Y side compound link 128a, a −Y side compound link 128b, a quadrangular frame-shaped fixed frame 129 with an opening in the Z axis direction and a quadrangular frame-shaped movable body connecting component 121 with an opening in the Z axis direction and configured within an inner peripheral side of the fixed frame 129. The fixed frame 129 is connected with an unshown fixed base. The movable body connecting component 121 is connected with an unshown movable body. The movable body is supported to move in directions perpendicular to the Z axis by the +Y side compound link 128a and the −Y side compound link 128b.

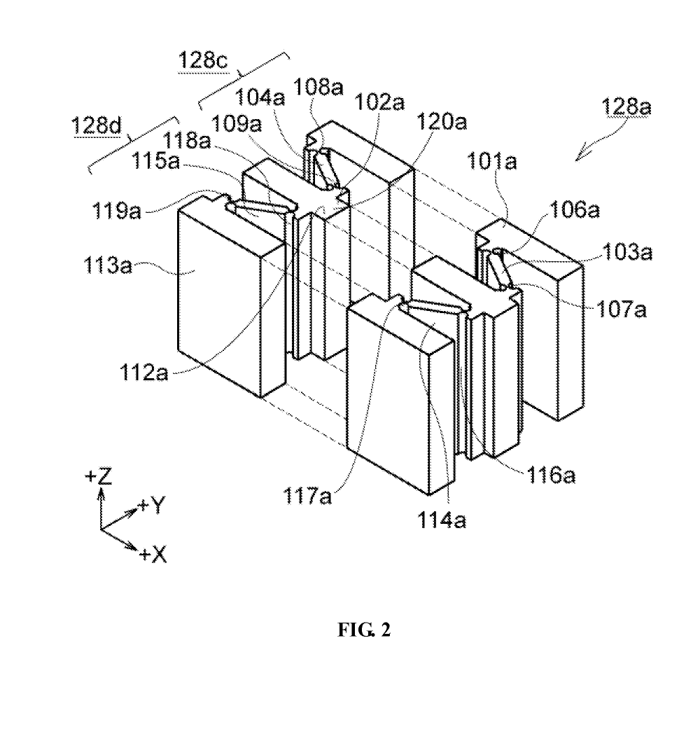

FIG. 2 is a perspective view of the +Y side compound link 128a. The +Y side compound link 128a and the −Y side compound link 128b are formed into the same structure, thus the +Y side compound link 128a is described in detail as an example.

Moreover, extension directions of the following joint axles 106a, 107a, 108a, 109a, 116a, 117a, 118a and 119a are taken as the Z axis direction (+Z direction, +Z side), and two axes which are mutually orthogonal and orthogonal to the Z axis are taken as an X axis direction (+X direction, +X side) and a Y axis direction (+Y direction, +Y side) respectively.

As shown in FIG. 2, the +Y side compound link 128a mainly includes an outside parallel link 128c and an inside parallel link 128d. The outside parallel link 128c is connected with an outside fixed link 101a and an outside output link 102a through a first outside active link 103a and a second outside active link 104a. The inside parallel link 128d is connected with an inside fixed link 112a and an inside output link 113a through a first inside active link 114a and a second inside active link 115a.

The outside parallel link 128c includes the tabulate outside fixed link 101a, the tabulate outside output link 102a, the first outside active link 103a, the second outside active link 104a and a plurality of joint axles 106a, 107a, 108a and 109a between the first outside active link 103a and the second outside active link 104a. The outside fixed link 101a is used for bearing the inside output link 113a to move in any direction forming a right angle with the Z axis. The joint axles 106a, 107a, 108a and 109a form hinges provided with cutting grooves, and are prolonged along the Z axis direction. Moreover, the inside parallel link 128d includes the tabulate inside fixed link 112a, the tabulate inside output link 113a, the first inside active link 114a, the second inside active link 115a, and a plurality of joint axles 116a, 117a, 118a and 119a between the first inside active link 114a and the second inside active link 115a. The joint axles 116a, 117a, 118a and 119a form the hinges provided with the cutting grooves, and are prolonged along the Z axis direction.

Therefore, in the embodiment, each of the +Y side compound link 128a and the −Y side compound link 128b includes a combination of the outside parallel link 128c and the inside parallel link 128d (a pair (a group) of parallel links). Moreover, the bearing mechanism 100 as shown in FIG. 1 includes a pair (a group) of compound links (namely four parallel links) formed by combining the +Y side compound link 128a (one) and the −Y side compound link 128b (one).

The joint axles 106a, 107a, 108a and 109a enable the first outside active link 103a and the second outside active link 104a assembled on the −X side of the first outside active link 103a in parallel to be connected mutually and to rotate around the axis parallel to the Z axis. The outside fixed link 101a bears the outside output link 102a, so that the link 102a is enabled to move in a fan-shaped track within a plane (in the X axis direction and Y axis direction) perpendicular to the Z axis.

The joint axles 116a, 117a, 118a and 119a enable the first inside active link 114a and the second inside active link 115a assembled on the −X side of the first inside active link 114a in parallel to be connected mutually and to rotate around the axis parallel to the Z axis. The inside fixed link 112a bears the inside output link 113a, so that the link 113a is enabled to move in a fan-shaped track in the plane perpendicular to the Z axis.

Therefore, the inside fixed link 112a and the outside output link 102a are mutually connected, thus the inside parallel link 128d is serially connected with the outside parallel link 128c from the −Y side so as to form the +Y side compound link 128a as shown in FIG. 1.

Moreover, the connected outside output link 102a and inside fixed link 112a are integrally formed into a middle link 120a.

The −Y side compound link 128b is assembled on the −Y side in the same conception of the compound link 128a, and the +Y side compound link 128a and the −Y side compound link 128b are respectively connected to the movable body connecting component 121 from the +Y side and the −Y side.

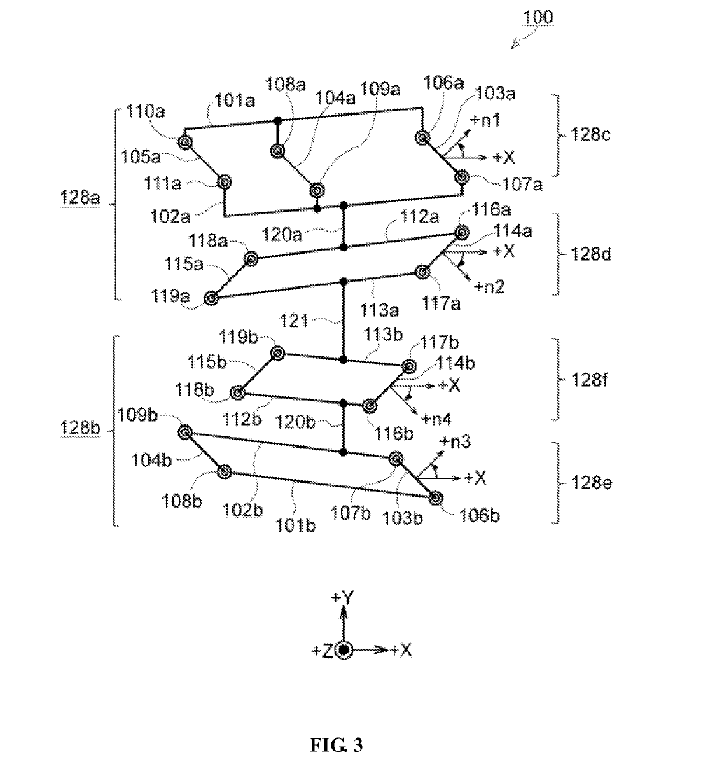

Namely, as shown in FIG. 1 and FIG. 3, the −Y side compound link 128b, the same as the +Y side compound link 128a, includes an outside parallel link 128e and an inside parallel link 128f. The outside parallel link 128e is connected with the outside fixed link 101b, the outside output link 102b, the first outside active link 103b and the second outside active link 104b respectively through the joint axles 106b, 107b, 108b and 109b. The inside parallel link 128f is connected with the inside fixed link 112b, the inside output link 113b, the first inside active link 114b and the second inside active link 115b respectively through the joint axles 116b, 117b, 118b and 119b. Moreover, the middle link 120b is used for connecting the outside output link 102b with the inside fixed link 112b to form integration. As mentioned above, the −Y side compound link 128b is formed by the outside parallel link 128e, the inside parallel link 128f and the middle link 129b.

Moreover, the outside fixed link 101a of the +Y side compound link 128a is connected to the fixed frame 129, the outside fixed link 101b of the −Y side compound link 128b is connected to the fixed frame 129, and the outside fixed link 101a and the outside fixed link 101b are mutually connected with the fixed frame 129 to form integration. The inside output link 113a of the +Y side compound link 128a is connected with the movable body connecting component 121 on the +Y side. Moreover, the inside output link 113b of the −Y side compound link 128b is connected with the movable body connecting component 121 on the −Y side, and the inside output link 113a and the inside output link 113b are mutually connected with the movable connecting component 121 to form integration.

That is to say, the bearing mechanism 100 enable the +Y side compound link 128a to connect with the −Y side compound link 128b through the movable body connecting component 121.

Moreover, as shown in a mode pattern diagram in FIG. 3, in the bearing mechanism 100 in the embodiment, when an outward normal line of a plane formed by the joint axles 106a and 107a on the two sides of the first outside active link 103a is set to be +n1, an outward normal line of a plane formed by the joint axles 116a and 117a on the two sides of the first inside active link 114a is set to be +n2, an outward normal line of a plane formed by the plane formed by the joint axles 106b and 107b on the two sides of the first outside active link 103b is set to be +n3, and an outward normal line of a plane formed by the joint axles 116b and 117b on the two sides of the first inside active link 114b is set to be +n4. The outward normal line +n1 of the +Y side compound link 128a tilts by an acute angle from the +X axis to the +Y side, the outward normal line +n2 of the +Y side compound link 128a tilts by an acute angle from the +X axis to the −Y side, the outward normal line +n3 of the −Y side compound link 128b tilts by an acute angle from the +X axis to the +Y side, the outward normal line +n4 of the −Y side compound link 128b tilts by an acute angle from the +X axis to the −Y side, and the movable body connecting component 121 is supported to move towards a direction perpendicular to the Z axis.

Relatively, the bearing mechanism 100 as shown in FIG. 1 is such formed that the outward normal line +n1 of the +Y side compound link 128a tilts by the acute angle from the +X axis to the +Y side, the outward normal line +n2 of the +Y side compound link 128a tilts by the acute angle from the +X axis to the −Y side, the outward normal line +n3 of the −Y side compound link 128b tilts by the acute angle from the +X axis to the −Y side, the outward normal line +n4 of the −Y side compound link 128b tilts by the acute angle from the +X axis to the +Y side.

That is to say, the orientations of the outward normal line +n3 and +n4 on the side of the −Y side compound link 128b in the bearing mechanism 100 as shown in FIG. 1 and the orientations of the outward normal line +n3 and +n4 on the side of the −Y side compound link 128b in the bearing mechanism 100 as shown in FIG. 3 are different from each other. Therefore, it could be comprehended that the outward normal line +n1 of the plane formed by the joint axles 106a and 107a in the +Y side compound link 128a tilts by the acute angle from the +X axis to any of +Y side and −Y side, and the outward normal line +n2 of the plane formed by the joint axles 116a and 117a in the +Y side compound ink 128a tilts by the acute angle from the +X axis to the other of +Y side and −Y side. And, the outward normal line +n3 of the plane formed by the joint axles 106b and 107b in the −Y side compound link 128b tilts by the acute angle from the +X axis to any of +Y side and −Y side, and the outward normal line +n4 of the plane formed by the joint axles 116b and 117b in the −Y side compound link 128b tilts by the acute angle from the +X axis to the other of +Y side and −Y side.

Therefore, a rotatable orientation of the first outside active link 103a and the second outside active link 104a in the +Y side compound link 128a and a rotatable orientation of the first inside active link 114a and the second inside active link 115a are mutually opposite, and a rotatable orientation of the first outside active link 103b and the second outside active link 104b in the −Y side compound link 128b and a rotatable orientation of the first inside active link 114b and the second inside active link 115b are mutually opposite. So that a rotatable range becomes larger. Therefore, a movable range of the movable body connecting component 121 is improved, thus the moving range of the movable body can be enlarged.

Moreover, the orientations of the outward normal lines +n1, +n2, +n3 and +n4 are not restricted to this, and are set according to requirements.

Moreover, in the bearing mechanism 100 as shown in FIG. 3, besides the first outside active link 103a and the second outside active link 104a, a third outside active link 105a is also configured on the −X side of the second outside active link 104a, and the outside fixed link 101a is connected with the outside output link 102a through the joint axles 110a and 111a, thus the outside parallel link 128c provided with three active links is formed.

Therefore, the active links are connected with the inside fixed link and the outside fixed link in parallel, and more than three active links may be used to form the connecting structure according to requirements.

Right now, the added outside active link 105a needs to be parallel to the outside active links 103a and 104a arranged in parallel, but the plane formed by the joint axles 106a and 108a on the side of the outside fixed link 101a does not need to be parallel to the plane formed by the joint axles 108a and 110a.

Moreover, the plane formed by the joint axles 106a and 108a on the side of the outside fixed link 101a, the plane formed by the joint axles 116a and 118a on the side of the inside fixed link 112a, the plane formed by the joint axles 106b and 108b on the side of the outside fixed link 101b and the plane formed by the joint axles 116b and 118b on the side of the inside fixed link 112b can also be not parallel to one another.

And then, an angle formed by the outward normal line +n1 and the +X axis and an angle formed by the outward normal line +n2 and the +X axis do not need to be the same as each other, an angle formed by the outward normal line +n3 and the +X axis and an angle formed by the outward normal line +n4 and the +X axis do not need to be the same as each other, that is, the angles can also be formed into different sizes according to requirements.

The bearing mechanism 100 as mentioned above is formed by connecting the +Y side compound link 128a and the −Y side compound link 128b with the movable body connecting component 121 in parallel from the +Y side and the −Y side in a balanced manner. Therefore, even if a rotary torque rotating around axis parallel to the Z axis acts on the movable body connecting component 121, the movable body connecting component 121 will not rotate around the axis parallel to the Z axis.

Moreover, under the condition that the movable body connecting component 121 receives an acting force in the Z axis direction, for example, the acting force is applied towards the +Z direction, as shown in an arrow Ωn in FIG. 1, a running torque Ωn rotating clockwise around the −X direction is applied on the side of the +Y side compound link 128a; as shown in an arrow Ωp, a running torque Ωp rotating around the +X direction in a right direction (clockwise rotation) is applied on the side of the −Y side compound link 128b. The movable body connecting component 121 supported by the +Y side compound link 128a and the −Y side compound link 128b from the two sides in a balanced manner enables the running torque Ωn and the running torque Ωp to offset each other. Thus the problem that the +Y side compound link 128a or the −Y side compound link 128b is twisted or tilts around the axis perpendicular to the Z axis or is deviated towards the Z axis direction cannot occur, and the problem of rotation around the axis parallel to the Z axis cannot occur.

In this way, the bearing mechanism 100 can be used for bearing the movable body connecting component 121 so that the movable body connecting component 121 cannot rotate in a non-dispositional direction. Therefore, the bearing mechanism 100 can successfully and accurately enable the following lens driving device 201 to move just parallelly to the directions perpendicular to the Z axis, and friction cannot be generated.

Moreover, in the first embodiment of the present invention, the hinges (cutting groove hinges) provided with cutting grooves are taken as the joint axles 106a to 111a, 116a to 119a, 106b to 109b, 1116b to 119b for description, but are not restricted to this, and pin hinges with their axes prolonged along the Z axis direction also can be used.

Moreover, under the condition that the cutting groove hinges are adopted in the joint axles 106a to 111a, 116a to 119a, 106b to 109b, 1116b to 119b, the elastic resilience of the cutting groove hinges is utilized for applying an acting force to the movable body connecting component 121 towards an initial position of the movable body connecting component 121, and the movable body connecting component 121 can be kept at the initial position when the movable body connecting component 121 does not receive external force. Unshown spring components can be installed between the movable body connecting component 121 and the fixed frame 129, so that the movable body connecting component can be kept at the initial position when the spring components do not receive external forces.

Moreover, in the above mentioned embodiment, the outside fixed link 101a, the outside output link 102a, the first outside active link 103a, the second outside active link 104a, the inside fixed link 112a, the inside output link 113a, the first inside active link 114a, the second inside active link 115a, the outside fixed link 101b, the outside output link 102b, the first outside active link 103b, the second outside active link 104b, the inside fixed link 112b, the inside output link 113b, the first inside active link 114b and the second inside active link 115b are all formed to be tabulate shaped respectively, but also can be not restricted to this to form bent plate-shaped or column-shaped.

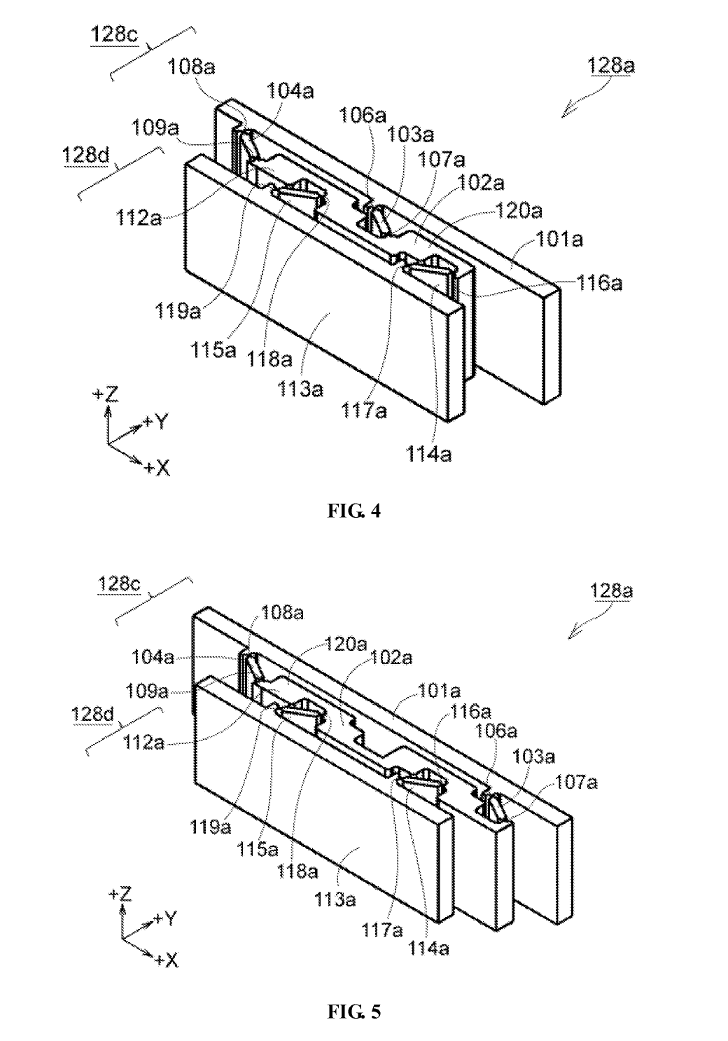

Referring to FIG. 4 to FIG. 6, various other embodiments of the +Y side compound link 128a are described.

For example, the +Y side compound link 128a as shown in FIG. 4 includes an outside parallel link 128c and an inside parallel link 128d. The outside parallel link 128c is formed by respectively connecting a tabulate outside fixed link 101a, a bent axle-shaped and tabular outside output link 102a, a tabulate first outside active link 103a and a tabulate second outside active link 104a through a plurality of joint axles 106a, 107a, 108a and 109a prolonged along the Z axis direction. The inside parallel link 128d is formed by respectively connecting an inside fixed link 112a which is bent axle-shaped and formed to be tabular, a tabulate inside output link 113a, a tabulate first inside active link 114a and to tabulate second inside active link 115a through joint axles 116a, 117a, 118a and 119a prolonged along the Z axis direction.

In the embodiment, the inside parallel link 128d is arranged on the −Y side of the outside parallel link 128c, and is serially connected to the outside parallel link 128c from the −Y side at the state of being biased to the +X direction. Moreover, in the embodiment, the middle link 120a is formed by mutually connecting the outside output link 102a and the inside fixed link 112a into one body.

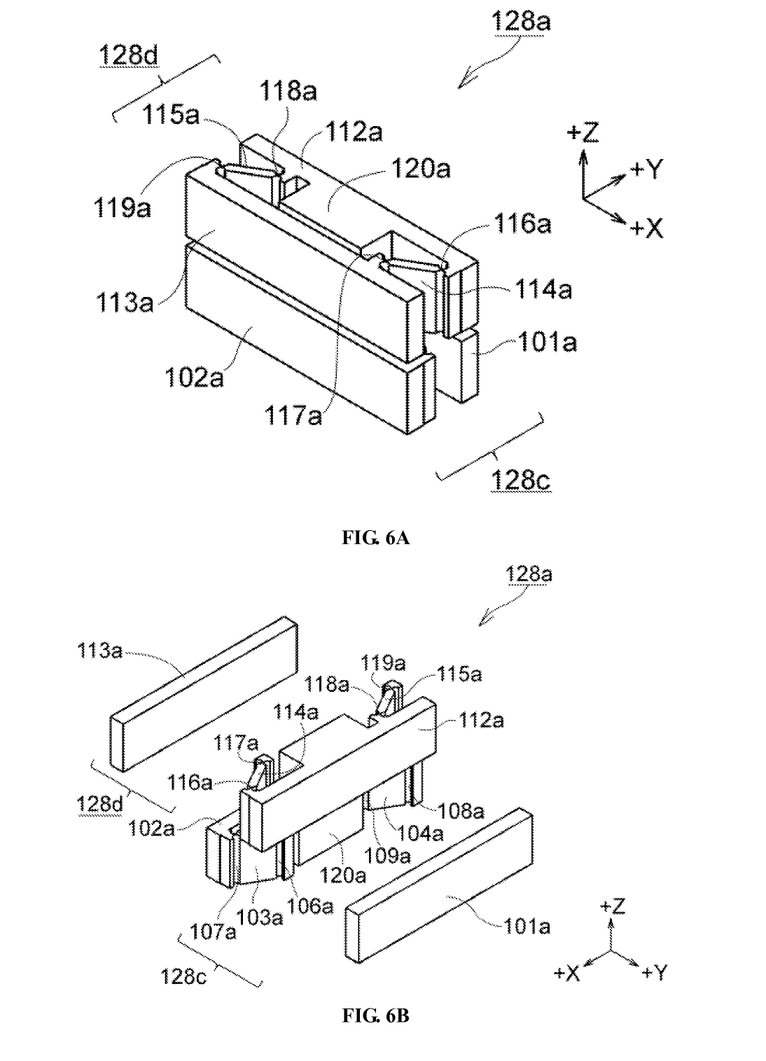

For example, the +Y side compound link 128a as shown in FIG. 5 includes an outside parallel link 128c and an inside parallel link 128d. The outside parallel link 128c is formed by connecting a tabulate outside fixed link 101a, a bent axle-shaped and tabular outside output link 102a, a tabulate first outside active link 102a and a tabulate second outside active link 104a through joint axles 106a, 107a, 108a and 109a prolonged along the Z axis direction. The inside parallel link 128d is formed by respectively connecting the an inside fixed link 112a which is bent axle-shaped and formed to be tabular, a tabular inside output link 113a, a tabulate first inside active link 114a and a tabulate second inside active link 115a through joint axles 116a, 117a, 118a and 119a prolonged along the Z axis direction.

In the embodiment, an interval between the joint axle 106a and the joint axle 108a in the outside parallel link 128c is set to be greater than an interval between the joint axle 116a and the joint axle 118a in the inside parallel link 128d, and the inside parallel link 128d is serially connected onto the outside parallel link 128c from the −Y side. Moreover, in the example, the middle link 120a is formed by mutually connecting the outside output link 102a and the inside fixed link 112a into one body.

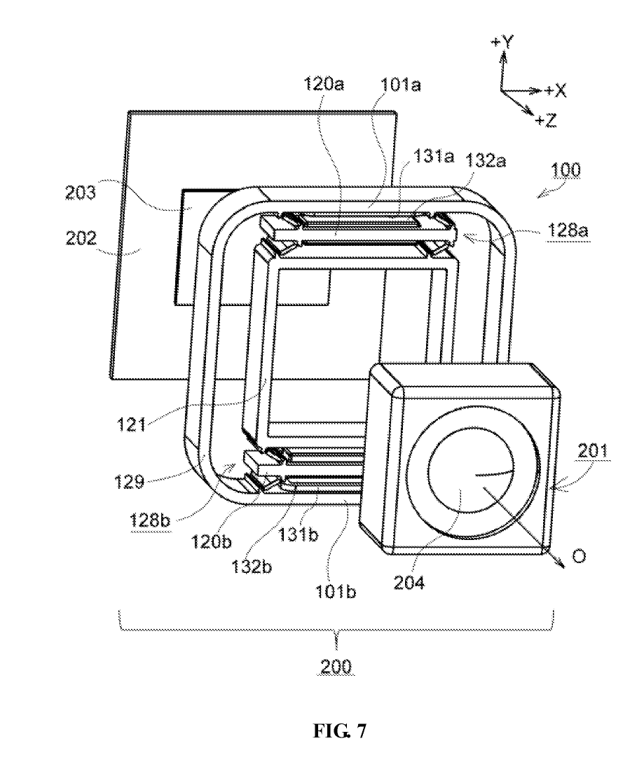

Moreover, as shown in FIG. 6A, the manner that the inside parallel link 128d and the outside parallel link 128c of the +Y side compound link 128a are mutually connected along the Z axis direction is different from the connection manners of the embodiments mentioned above.

That is, as shown in FIG. 6B, the +Y side compound link 128a includes the outside parallel link 128c and the inside parallel link 128d. The outside parallel link 128c is formed by respectively connecting a tabulate outside fixed link 101a, a bent axle-shaped and tabular outside output link 102a, a tabulate first outside active link 103a and a tabulate second outside active link 104a through the joint axles 106a, 107a, 108a and 109a prolonged along the Z axis direction. The inside parallel link 128d is formed by respectively connecting an inside fixed link 112a which is bent axle-shaped and formed to be tabular, a tabular inside output link 113a, a tabulate first inside active link 114a and a tabulate second inside active link 115a through joint axles 116a, 117a, 118a and 119a prolonged along the Z axis direction.

A column-shaped middle link 120a prolonged along the Z axis direction enables the outside output link 102a and the inside fixed link 112a to form integration so as to serially connect the inside parallel link 128d with the outside parallel link 128c.

Moreover, in the FIG. 6B the outside fixed link 101a and the inside output link 113a are cut off from the +Y side compound link 128a, so as to observe the interior structure of the outside fixed link 101a and the inside output link 113a.

Even though, the +Y side compound link 128a and the −Y side compound link 128b with the shapes as shown in FIG. 4 to FIG. 6 are used for replacing the +Y side compound link 128a with the shape as shown in FIG. 2 so as to form the bearing mechanism 100. Similar to the bearing mechanism 100 as shown in FIG. 1, one pair (two) compound links composed of the +Y side compound link 128a and the −Y side compound link 128b are utilized for bearing the movable body connecting component 121 in a balanced manner from the two sides: the +Y direction and the −Y direction. Therefore, even if the movable body connecting component 121 receives the effect of a rotary torque rotating around the axis parallel to the Z axis, the movable body connecting component 121 also cannot rotate around the axis parallel to the Z axis.

Moreover, even if the movable body connecting component 121 receives the acting force in the Z axis direction, the movable body connecting component 121 can also receive the bearing for keeping the +Y side compound link 128a and the −Y side compound link 128b to be balanced on the two sides, thus the +Y side compound link 128a and the −Y side compound link 128b cannot rotate around the axis perpendicular to the Z axis and tilt, or cannot be out of position in the Z axis direction.

Therefore, the bearing mechanism 100 cannot generate friction, and the movable body connecting component 121 is supported to move just parallel to the directions perpendicular to the Z axis accurately, but cannot rotate around the axis parallel to the Z axis and the axis perpendicular to the Z axis.

Moreover, the +Y side compound links 128a with various shapes have been shown in FIG. 4 to FIG. 6, and the −Y side compound link 128b can also be formed similarly.

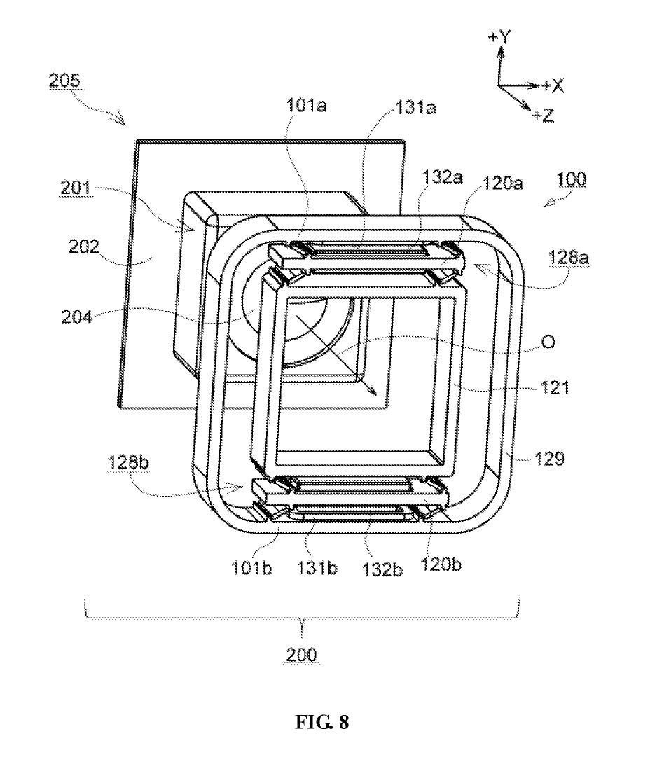

FIG. 7 is a perspective view of a hand shaking correction device 200 using the bearing mechanism based on the first embodiment of the present invention.

In the bearing mechanism 100, magnetized permanent magnets 132a and 132b for swinging a lens along the Y axis direction are installed on the middle link 120a of the +Y side compound link 128a and the middle link 120b of the −Y side compound link 128b. Moreover, a coil 131a for swinging the lens wound on the −Y side inner wall of the outside fixed link 101a around the Y axis direction and a coil 131b for swinging the lens wound on the +Y side inner wall of the outside fixed link 101b around the Y axis direction are respectively installed. The coils 131a, 131b are configured to face the permanent magnets 132a and 132b respectively at an interval in the Y axis direction. Under this condition, the coils 131a and 131b and the permanent magnets 132a and 132b are taken as driving mechanism to operate.

When the coils 131a and 131b are electrified, the coils 131a and 131b utilize the mutual effect between the permanent magnets 132a and 132b which are arranged opposite to each other to generate a coulomb force in the Y axis direction, thus the movable body connecting component 121 can be enabled to swing in the direction (directions of X axis and Y axis) perpendicular to the Z axis direction by suitably setting the current direction and the current intensity delivered in the coils 131a and 131b.

Specifically, for example, under the condition that the magnetic pole faces, arranged opposite to the coils 131a and 131b, of the permanent magnets 132a and 132b are taken as N poles and the current rotating in clockwise direction around the +Y direction is delivered to the coil 131a of the +Y side compound link 128a, the coil 131a generates the coulomb force in the −Y direction, and the permanent magnet 132a which is arranged opposite to the coil 131a receives the effect of a counter-acting force in the +Y direction. Moreover, similarly, under the condition that the current rotating in clockwise direction around the +Y direction is delivered to the coil 131b on the side of the −Y side compound link 128b, the coil 131b generates the coulomb force in the −Y direction, and the permanent magnet 132b arranged opposite to the coil 131b receives the effect of the counter-acting force in the +Y direction.

Therefore, under the condition that the current rotating in the clockwise direction around the +Y direction is delivered to the coil 131a and the current rotating in the clockwise direction around the +Y direction is delivered to the coil 131b, the middle links 120a and 120b on the two sides move towards the +Y direction, and the movable body connecting component 121 moves towards the +Y direction.

Similarly, under the condition that the current rotating in the counterclockwise direction around the +Y direction is delivered to the coil 131a and the current rotating in the counterclockwise direction around the +Y direction is delivered to the coil 131b, the middle links 120a and 120b on the two sides move towards the −Y direction, and the movable body connecting component 121 moves towards the −Y direction.

And then, under the condition that the current rotating in the clockwise direction around the +Y direction is delivered to the coil 131a and the current rotating in the counterclockwise direction around the +Y direction is delivered to the coil 131b, the middle links 120a on the side of the +Y side compound link 128a moves towards the +Y direction, the middle link 120b on the side of the −Y side compound link 128b moves towards the −Y direction, and the movable body connecting component 121 moves towards the +X direction.

And then, under the condition that the current rotating in the counterclockwise direction around the +Y direction is delivered to the coil 131a and the current rotating in the clockwise direction around the +Y direction is delivered to the coil 131b, the middle links 120a on the side of the +Y side compound link 128a moves towards the −Y direction, the middle link 120b on the side of the −Y side compound link 128b moves towards the +Y direction, and the movable body connecting component 121 moves towards the −X direction.

The movable body connecting component 121 can be enabled to swing in any direction perpendicular to the Z axis direction by suitably setting the current intensity and the current direction delivered in the coils 131a and 131b.

As shown in FIG. 7, in the bearing mechanism 100 provided with the permanent magnets 132a and 132b and the coils 131a and 131b and taken as the driving mechanisms, the lens driving device 201 provided with the lens 204, by taking the direction of the optical axis as the O axis direction, as the movable body is installed on the movable body connecting component 121 of the bearing mechanism 100 in the manner that the O axis is parallel to the Z axis, and the base plate 202 for installing an image sensor 203 is connected to the fixed frame 129 of the bearing mechanism 100, thus the hand shaking correction device 200 is formed.

Namely, the lens driving device 201 is a device for enabling the lens 204 to realize auto focus so that the image of the shot object is focused on the image sensor 203, and the lens 204 can be enabled to move in the O axis direction (Z axis direction). Moreover, the coils 131a and 131b are electrified, the hand shaking correction 200 can enable the lens driving device 201 connected with the movable body connecting component 121 of the bearing mechanism 100 to swing in parallel along any direction perpendicular to the Z axis without generating friction. Therefore, the currents corresponding to the direction and the size generating hand shaking during shooting are supplied to the coils 131a and 131b, so that the lens driving device 201 can be enabled to swing parallel to the direction of reducing the image offset generated by the image sensor 203.

Moreover, in the embodiment, the lens driving device 201 is taken as an example for describing the movable body installed on the movable body connecting component 121, but can also be used as a replacement, the base plate 202 provided with the image sensor 203 is installed on the movable body connecting component 121, and the lens driving device 201 is installed on the fixed frame 129, and then the fixed frame 129 is installed on the unshown fixed base, so that the image sensor 203 and the base plate 202 can swing together.

Moreover, as the driving mechanisms, the joint axles 106a to 111a and 116a to 119a formed on the +Y side compound link 128a or the joint axles 106b to 109b and 116b to 119b formed on the −Y side compound link 128b also can be formed by artificial muscles composed of macromolecules such as EAPs (Electroactive Polymers) so as to replace the electromagnetic driving mechanism mentioned above. The artificial muscles are bent so as to enable the movable body connecting component 121 to swing, thus the hand shaking correction device 200 is formed.

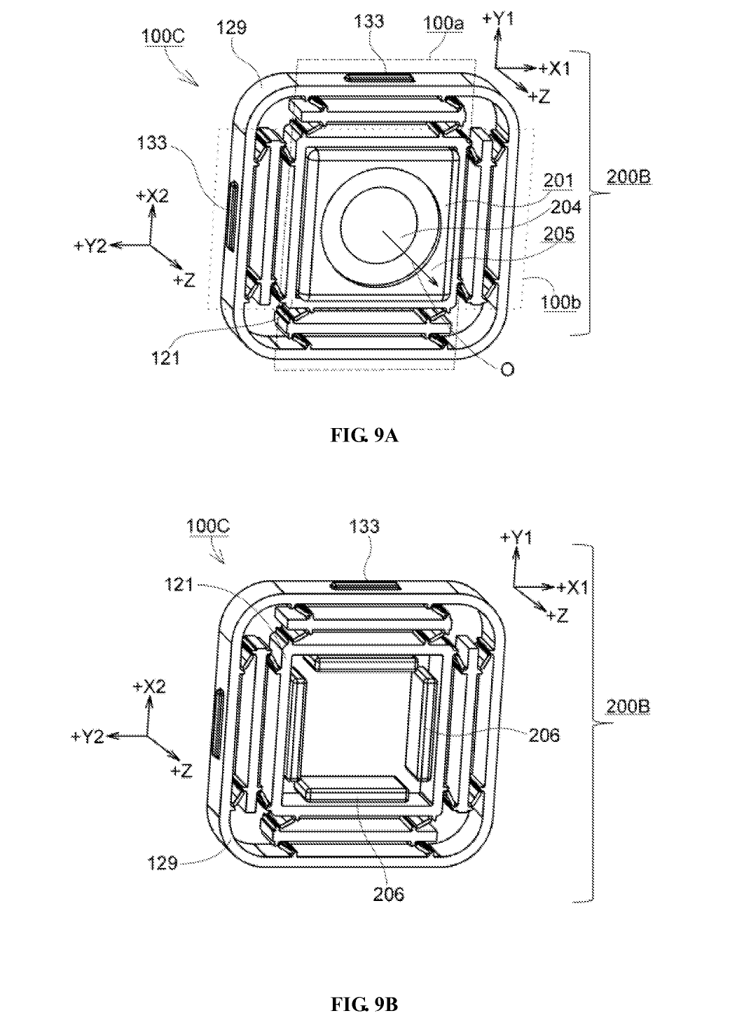

Moreover, as shown in FIG. 8, as another forming manner of the hand shaking correction device 200, a camera assembly composed of the lens driving device 201 and the base plate 202 for installing the graphical image sensor not shown in the figures also can be installed on the movable body connecting component 121 as the movable body.

Under this condition, in the manner that the O axis direction, taken as the optical axis of the lens 204, is parallel to the Z axis, the camera assembly 205 is installed on the movable body connecting component 121 of the bearing mechanism 100, and the fixed frame 129 is installed on the unshown fixed base. Moreover, similar to the example of FIG. 7, the electromagnetic driving mechanism composed of the permanent magnets 132a and 132b and the coils 131a and 131b is installed. If the currents corresponding to the direction and the size generating hand shaking during shooting are supplied to the coils 131a and 131b, the hand shaking correction device 200 can be provided for enabling the whole camera assembly 205 to swing in the direction of overcoming the hand shaking so as to reduce the vibration.

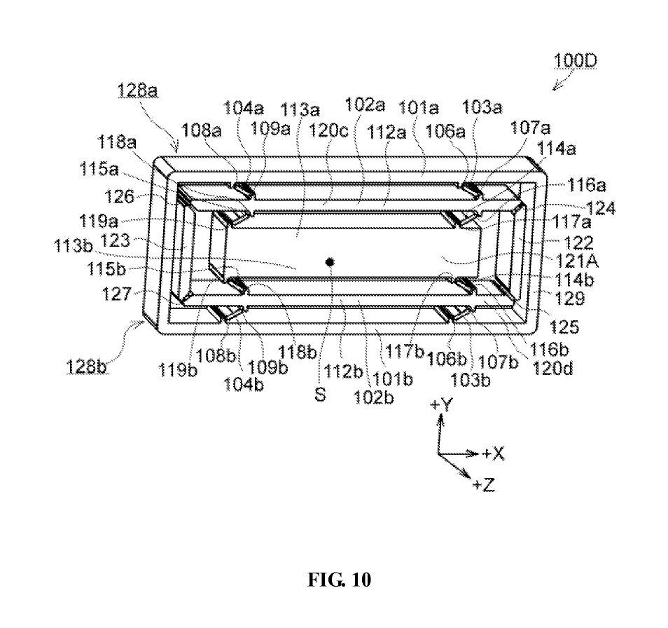

FIG. 9A and FIG. 9B are perspective views illustrating a hand shaking correction device 200B using a bearing mechanisms 100C of the present invention.

As shown in FIG. 9A, the bearing mechanism 100C is positioned at the position closer to the outside than the quadrangular frame-shaped movable body connecting component 121 with an opening in the Z axis direction, and is formed by combining two bearing mechanisms 100a and two bearing mechanisms 100b assembled at the positions of rotating by 90 degrees around the axis parallel to the Z axis respectively. That is to say, the difference between the bearing mechanism 100C of the embodiment and that of the embodiments mentioned above lies in that two pairs of compound links are provided.

In an X1Y1Z three-dimensional orthogonal coordinate system of the bearing mechanism 100C, the bearing mechanism 100C as shown in long imaginary line frame lines is provided with an opening in the Z axis direction, and is installed in the Y1 axis direction of the quadrangular frame-shaped movable body connecting component 121. Moreover, in an X2Y2Z three-dimensional orthogonal coordinate system rotating by 90 degrees around the axis parallel to the Z axis, the bearing mechanisms 100b as shown in short imaginary line frame lines are installed in the Y2 axis direction of the movable body connecting component 121. Namely, the bearing mechanism 100a on the Y1 side or the bearing mechanism 100b on the Y2 side is a mechanism rotating by 90 degrees around the O axis parallel to the Z axis respectively, and is connected in parallel respectively. Moreover, magnets 133 for the suspension are provided with an opening in the Z axis direction, and are respectively installed at central parts of outer walls of four frame piece of the quadrangular frame-shaped fixed frame 129.

Moreover, in the example, the movable body connecting component 121 is provided with the lens 204 by taking the optical axis as the O axis, and is used for connecting the lens driving device 201 for moving along the O axis direction to realize auto focus with the camera assembly for installing the unshown image sensor. Namely, the lens driving device 201 installed in the camera assembly 205 enables the O axis to face to the direction parallel to the Z axis, and is retained at the state that the camera assembly 205 is inserted in the inner wall side of the movable body connecting component 121. The fixed frame 129 is fixed on the unshown fixed base.

FIG. 9B is a perspective view when components such as the lens driving device 201 and the like are disassembled. As shown in figure, on the inner side of the lens driving device 201, cuboid-shaped permanent magnets 206 for auto focus are assembled around the periphery of the axis, parallel to the Z axis, of the lens 204 as shown in FIG. 9A by 90 degrees at intervals. Each permanent magnet 206 for auto focus and each magnet 133 for the suspension installed inside the fixed frame are partitioned at an interval and arranged opposite to each other in the Y1 axis direction or the Y2 axis direction.

Therefore, the permanent magnets 206 for auto focus and the magnets 133 for the suspension assembled on the +Y1 side receive the magnetization in the +Y1 direction, and the magnetic pole faces, with the same polarity, of the permanent magnets 206 for auto focus and the magnets 133 for the suspension are arranged opposite to each other. Similarly, the permanent magnets 206 for auto focus and the magnets 133 for the suspension assembled on the −Y1 side receive the magnetization in the +Y1 direction, and the magnetic pole faces, with the same polarity, of the permanent magnets 206 for auto focus and the magnets 133 for the suspension are arranged opposite to each other. Therefore, the permanent magnets 206 for auto focus and the magnets 133 for the suspension assembled on the +Y2 side receive the magnetization in the +Y2 direction, and the magnetic pole faces, with the same polarity, of the permanent magnets 206 for auto focus and the magnets 133 for the suspension are arranged opposite to each other. In addition, the permanent magnets 206 for auto focus and the magnets 133 for the suspension assembled on the −Y2 side receive the magnetization along the +Y2 direction, and the magnetic pole faces, with the same polarity, of the permanent magnets 206 for auto focus and the magnets 133 for the suspension are arranged opposite to each other.

In this way, the hand shaking correction device 200B is utilized for corresponding to the permanent magnets 206 for auto focus assembled on the periphery of the axis parallel to the Z axis at intervals by 90 degrees so that the magnets 133 for the suspension are assembled in the manner that the magnetic pole faces, with the same polarity, of both (namely, the magnets 133 for the suspension and the permanent magnets 206 for auto focus) are arranged opposite to each other, thus the permanent magnets 206 for auto focus are at the state that the effect of repulsive force of the magnets 133 for the suspension is received from four directions of orthogonal to the Z axis to the center. Moreover, the camera assembly 205 is suspended on the bearing mechanism 100C at the state that the effect of repulsive force from the magnets 133 for the suspension is received. Therefore, the repulsive force is strengthened when the intervals between the permanent magnets 206 for auto focus and the magnets 133 for the suspension become narrower, and the repulsive force is weakened when the intervals become wider, thus the camera assembly 205 is suspended at the state that the effect of resilience facing to the center of the fixed frame is received all the time. Namely, the camera assembly 205 is suspended at a free state.

Therefore, when hand shaking of the hand shaking correction device 200B which is provided with the camera assembly 205 suspended at the free state occurs, the fixed frame 129 moves in the direction orthogonal to the Z axis due to the hand shaking, but the camera assembly 205 suspended on the bearing mechanism 100C can utilize an inertia effect to maintain the static state relative to the shot object. When the hand shaking correction device 200B absorbs the generated hand shaking, the camera assembly 205 is returned back to the center of the fixed frame 129. Namely, during the hand shaking, only the fixed frame 129 swings, and the camera assembly 205 connected with the movable body connecting component 121 can utilize inertia to be at a static state.

In this way, the hand shaking correction device 200B also can utilize a simple and easy mechanism to realize hand shaking correction without using the driving mechanisms.

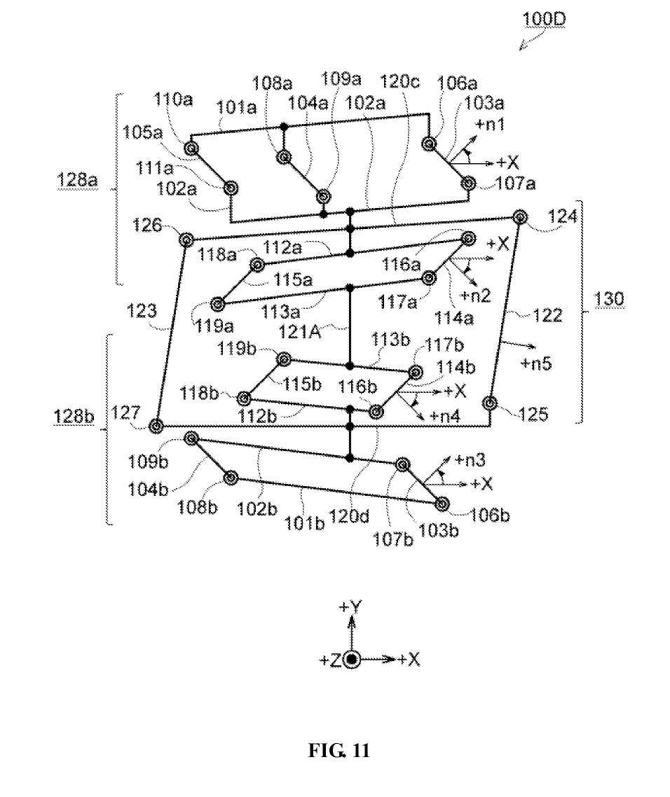

FIG. 10 is a perspective view of a bearing mechanism in according to a second embodiment of the present invention.

The bearing mechanism 100D, similar to the forming components as shown in FIG. 1 to FIG. 3, includes the +Y side compound link 128a, the −Y side compound link 128b, the quadrangular frame-shaped fixed frame 129 with an opening in the Z axis direction, a quadrangular movable body connecting component 121 arranged on the inner peripheral side of the fixed frame 129, the middle link 120c on the side of the +Y side compound link 128a for connecting the outside output link 102a with the inside fixed link 112a, the middle link 120d on the side of the −Y side compound link 128b for connecting the outside output link 102b with the inside fixed link 112b, a tabulate +X side restricted link 122 for connecting the middle link 120c (the outside output link 102a and the inside fixed link 112a) with the middle link 120d (the outside output link 102b and the inside fixed link 112b), and a tabulate −X side restricted link 123 for connecting the middle link 120c (the outside output link 102a and the inside fixed link 112a) with the middle link 120d (the outside output link 102b and the inside fixed link 112b).

Compared with the +Y side compound link 128a and the −Y side compound link 128b in the first embodiment, the basic structures of the +Y side compound link 128a and the −Y side compound link 128b in the bearing mechanism 100D of the second embodiment of the present invention are the same, but the movable body connecting component 121A is solid, and the middle links 120c and 120d are prolonged on the +X side and the −X side. Moreover, the +Y side compound link 128a and the −Y side compound link 128b in the first embodiment and the second embodiment are almost of the same structure, thus the description of both is omitted.

The middle link 120c of the +Y side compound link 128a and the middle link 120d of the −Y side compound link 128b are both prolonged so that the lengths exceed the width of the movable body connecting component 121A in the X axis direction. One end of the +X side restricted link 122 on the +X side is composed of hinges with cutting grooves, and is connected with the middle link 120c through the joint axle 124 prolonged along the Z axis direction. The other end of the +X side restricted link 122 is composed of hinges with cutting grooves, and is connected with the middle link 120d through the joint axle 125 prolonged along the Z axis direction.

In addition, one end of the −X side restricted link 123 on the −X side is composed of hinges with cutting grooves, and is connected with the middle link 120c through the joint axle 126 prolonged along the Z axis direction. The other end of the −X side restricted link 123 is composed of hinges with cutting grooves, and is connected with the middle link 120d through the joint axle 127 prolonged along the Z axis direction.

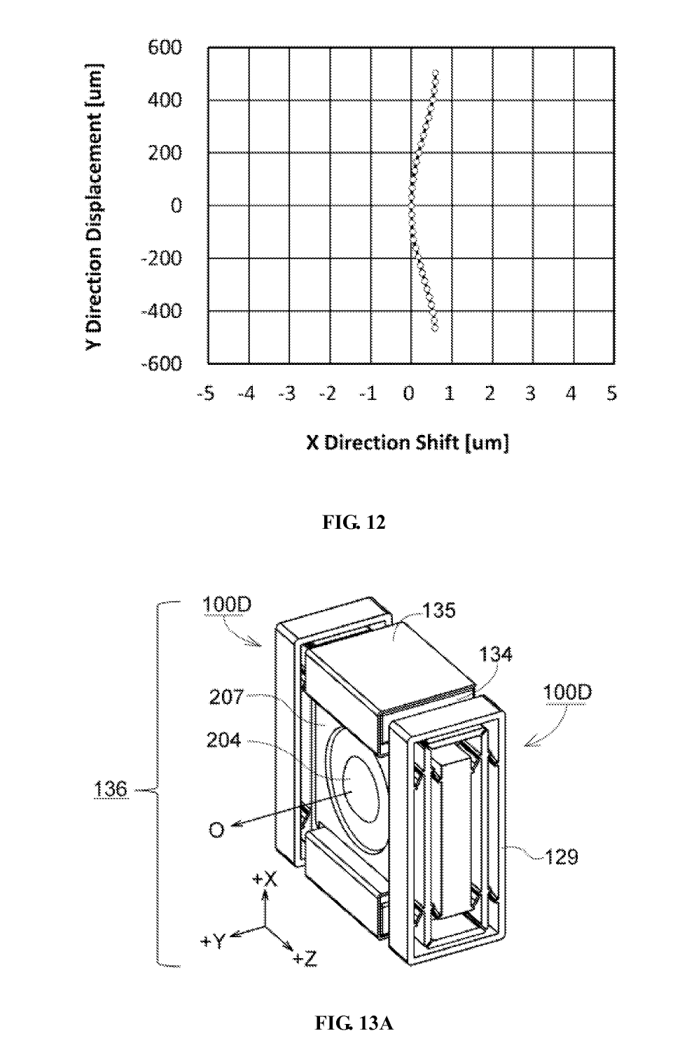

Moreover, as shown in FIG. 11, the middle link 120c, the middle link 120d, the +X side restricted link 122, the −X side restricted link 123 and the joint axles 124 to 127 form a displacement restriction parallel link 130. Namely, the joint axle 124, the joint axle 125, the joint axle 127 and the joint axle 126 are connected together in sequence to form a parallelogram, and the +X side restricted link 122 and the −X side restricted link 123 interact with each other and can rotate around the axis parallel to the Z axis.

Therefore, when the bearing mechanism 100D utilizes the restricted link 122 to enable the movable body connecting component 121A to move, the distance between the joint axle 124 and the joint axle 125 can be kept in constant. Therefore, under the condition that the bearing mechanism 100D is used, the +Y side compound link 128a and the −Y side compound link 128b are used for restricting a movable range of the movable body connecting component 121A in the plane perpendicular to the Z axis direction, and the displacement restriction parallel link 130 can be used for restricting only the movable range of the movable body connecting component 121A in the Y axis direction.

Right now, in the bearing mechanism 100D, even if the movable body connecting component 121 receives the effect of a rotary torque rotating around the axis parallel to the Z axis, the movable body connecting component 121 also cannot rotate around the axis parallel to the Z axis. Moreover, even if the movable body connecting component 121 receives the acting force in the Z axis direction, and also receive the bearing for keeping the +Y side compound link 128a and the −Y side compound link 128b to be balanced on the two sides, thus the movable body connecting component 121A cannot rotate around the axis perpendicular to the Z axis and tilt, or cannot be out of position in the Z axis direction.

Therefore, the bearing mechanism 100 can support the movable body connecting component 121A without generating friction to move just parallel to the Y axis direction accurately, and enables the movable body connecting component 121A not to rotate around the axis parallel to the Z axis and the axis perpendicular to the Z axis.

Moreover, in the embodiments as shown in FIG. 10 and FIG. 11, even if the restricted link 123 is omitted, the middle link 120c can be connected with the middle link 120d through the joint axles 124 and 125 by only one single restricted link 122. In addition, if the restricted link 123 and the restricted link 122 are connected in parallel and a plurality of restricted links 123 and restricted links 122 are connected in parallel repeatedly, the change of the interval between the middle link 120c and the middle link 120d can be stabilized. In addition, in the displacement restriction parallel link 130, as long as the orientation of the normal line +n5 of the plane formed by the joint axle 124 and the joint axle 125 and the Z axis form the right angle without other restriction.

In addition, similar to the bearing mechanism 100 as shown in FIG. 3, the bearing mechanism 100D also can be used in the more than two additionally arranged connecting structures of the active links 103a, 103b, 104a, 104b, 105a, 114a, 114b, 115a and 115b for connecting the inside fixed link 112a and 112b with the outside fixed links 101a and 101b in parallel.

Moreover, the plane formed by the joint axles 106a and 108a on the side of the outside fixed link 101a, the plane formed by the joint axles 116a and 118a on the side of the inside fixed link 112a, the plane formed by the joint axles 106b and 108b on the side of the outside fixed link 101b and the plane formed by the joint axles 116b and 118b on the side of the inside fixed link 112b can also be not parallel to one another.

And then, the angle formed by the outward normal line +n1 and the +X axis, the angle formed by the outward normal line +n2 and the +X axis, the angle formed by the outward normal line +n3 and the +X axis and the angle formed by the outward normal line +n4 and the +X axis do not need to be the same as each other, and the angles with different sizes can also be formed according to requirements.

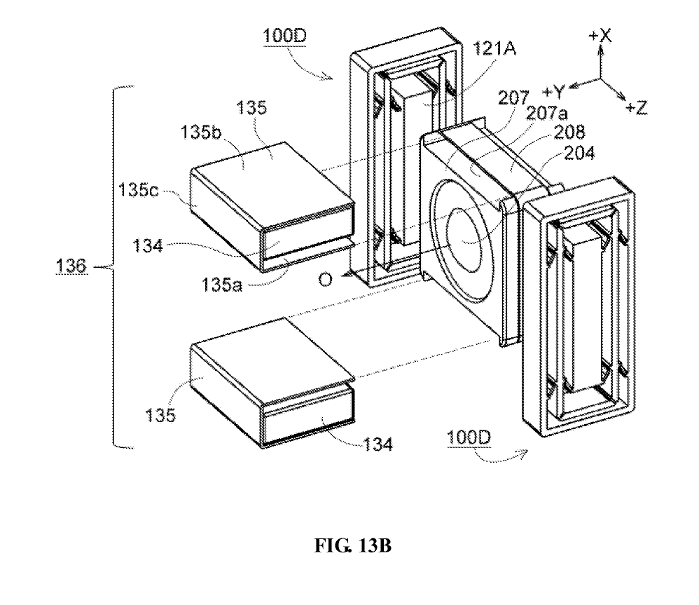

FIG. 12 is a curve chart illustrating the experimental results of a moving track of a point S (referring to FIG. 10) on the movable body connecting component 121A when the fixed frame 129 of the bearing mechanism 100D is fixed on the unshown fixed base and the movable body connecting component 121A moves.

The bearing mechanism 100D for measuring includes the +Y side compound link 128a and the −Y side compound link 128b in FIG. 10. The lengths of the active links of the compound links 128a and 128b are shown as follows. Namely, the interval between the joint axle 106a and the joint axle 107a, the interval between the joint axle 108a and the joint axle 109a, the interval between the joint axle 116a and the joint axle 117a, the interval between the joint axle 118a and the joint axle 119a, the interval between the joint axle 106b and the joint axle 107b, the interval between the joint axle 108b and the joint axle 109b, the interval between the joint axle 116b and the joint axle 117b and the interval between the joint axle 118b and the joint axle 119b are lmm respectively. Moreover, the length of the restricted link as the interval between the joint axle 124 and the joint axle 125 is 5 mm.

Moreover, the positions when the outward normal line +n1 tilts by 70 degrees to the +Y side relative to the +X axis, the outward normal line +n2 tilts by 70 degrees to the −Y side relative to the +X axis, the outward normal line +n3 tilts by 70 degrees to the −Y side relative to the +X axis, and the outward normal line +n4 tilts by 70 degrees to the +Y side relative to the +X axis are set as initial positions, namely the positions when the movable body connecting component 121A does not receive the effect of the external force. Moreover, the +Y side compound link 128a, the −Y side compound link 128b and the displacement restriction parallel link 130 are respectively assembled by enabling the normal line +n5 of the plane formed by the joint axle 124 and the joint axle 125 to be parallel to the X axis, so that the first outside active link 103a rotates so as to enable the outward normal line +n1 to change in the range of tilting by 55 to 85 degrees from the +X direction to the +Y side, and the moving track of the point S on the movable body connecting component 121A is measured.

According to the results as shown in FIG. 12, the movement of the movable body connecting component 121A is about 500 microns respectively from the initial position as the beginning point of moving towards the Y axis direction (+X axis directions and −X axis direction), and the movement in the X axis direction is restricted below 0.6 microns. In addition, if the length of the restricted link is prolonged, the movement of the movable connecting component 121A in the X axis direction can be restricted to be further smaller, for example, when the length of the restricted link is 10 mm, the movement towards the Y axis direction (+Y axis direction and −Y axis direction) is about 500 microns, and the movement towards the X axis direction is below 0.3 microns.

In this way, the bearing mechanism 100D is used for connecting the restricted link 122 between the middle link 120c and the middle link 120d, thus the movable body connecting component 121A cannot rotate around the axis parallel to the Z axis and the axis perpendicular to the Z axis respectively. Therefore, the bearing mechanism 100 can support the movable body connecting component 121 to move just parallel to the direction of Y axis accurately without generating friction, and not to rotate around the axis parallel to the Z axis and the axis perpendicular to the Z axis.

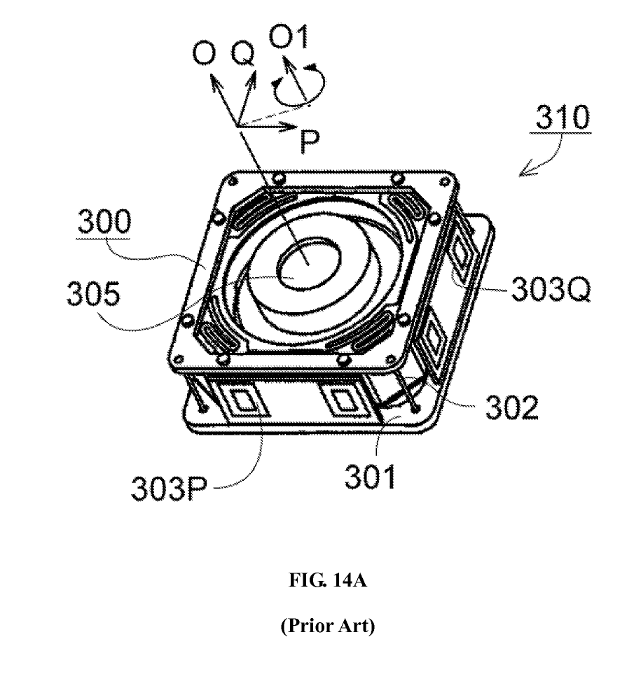

FIG. 13A and FIG. 13B are perspective views illustrating a lens driving device 136 using the bearing mechanism 100D based on the second embodiment of the present invention. As shown in FIG. 13A and FIG. 13B, the lens driving device 136 is composed of the lens 204, the lens support 207 as the movable body, the coil 208 for auto focus, the permanent magnet 134 for auto focus, the magnet yoke 135 and the bearing mechanism 100D. The lens 204 is installed on the lens support 207, and the O axis taken as the optical axis is parallel to the Y axis.

As shown in an exploded perspective view of FIG. 13B, the lens support 207 is formed into a cuboid shape with a circular opening in the Y axis direction so that the lens 204 is retained on the inside of the opening part. The coil 208 for auto focus is wound on the outer periphery of the Y axis of the lens support 207.

The bearing mechanism 100D is respectively assembled on the +Z side and the −Z side of the lens support 207. The face on the −Z side of the movable body connecting component 121A in the bearing mechanism 100D configured on the +Z side is connected with the side face on the +Z side of the lens support 207, the face on the +Z side of the movable body connecting component 121A in the bearing mechanism 100D configured on the −Z side is connected with the side face on the −Z side of the lens support 207, and the fixed frames 129 of the bearing mechanisms 100D on the two sides are connected with the unshown fixed base.

The permanent magnet 134 for auto focus is provided with the magnetic pole face in the X axis direction, and is formed into a quadrangular shape. The magnet yoke 135 is bent in a U shape.

One of the two boards arranged opposite to each other, of the magnet yoke 135, is formed into an outside magnet yoke sheet 135b, and one magnetic pole face of the permanent magnet 134 for auto focus is fixed on the inner side of the outside magnet yoke sheet 135b. In addition, the other board of the magnet yoke 135 is formed into an inside magnet yoke sheet 135a, and the inside magnet yoke sheet 135a and the other magnetic pole face of the permanent magnet 134 for auto focus are separated at an interval and arranged opposite to each other. On the +Y side of the permanent magnet 134 for auto focus, the outside magnet yoke sheet 135b is connected with the inside magnet yoke sheet 135a through a tabular connecting magnet yoke sheet 135c prolonged along the X axis direction.

The magnet yokes 135 for installing the permanent magnets 134 for auto focus are respectively assembled on the +X side and the −X side of the lens support 207, each inside magnet yoke sheet 135a is inserted in a gap part 207a formed between the side faces on the two sides of the +X side and the −X side of the lens support 207 and the inner peripheral side face of the coil 208 for auto focus from the +Y side, and the magnet yokes 135 are connected with sides of the fixed base. Right now, the inserted inside magnet yoke sheets 135a are respectively inserted between the lens support 207 and the coil 208 for auto focus in a non-contact manner.

In addition, the magnetic pole faces, which are arranged opposite to the coil 208 for auto focus, of the permanent magnet 134 for auto focus respectively assembled on the +X side and the −X side are of the same polarity.

Moreover, if the coil 208 for auto focus is electrified, electromagnetic interaction between the coil 208 for auto focus and the permanent magnet 134 for auto focus is utilized, and the coil 208 for auto focus generates the Lorentz force in the +Y direction, so that the lens support 207 can be enabled to move in the +Y direction.

In this way, the lens driving device 136, born by the bearing mechanism 100D, of the lens support 207 cannot move or rotate in any unwanted direction. Therefore, friction cannot be generated so that the lens support 207 can accurately move in parallel in the Y axis direction.

In addition, as the driving mechanisms, the joint axles 106a to 111a and the joint axles 116a to 119a formed on the +Y side compound link 128a or the joint axles 106b to 109b and the joint axles 116b to 119b formed on the −Y side compound link 128b also can be formed by the artificial muscles so as to replace the electromagnetic driving mechanisms utilizing the permanent magnet 134 for auto focus and the coil 208 for auto focus. The artificial muscles are bent so as to enable the movable body connecting component 121A to move, thus the lens driving device 136 is formed.

While the invention has been described in terms of several exemplary embodiments, those skilled on the art will recognize that the invention can be practiced with modification within the spirit and scope of the appended claims. In addition, it is noted that, the Applicant's intent is to encompass equivalents of all claim elements, even if amended later during prosecution.

What is claimed is:

1. A bearing mechanism for a movable body, comprising:
at least two compound links in an XYZ three-dimensional orthogonal coordinate system, each compound link comprising:
an outside parallel link; and
an inside parallel link;
wherein the outside parallel link comprises:
an outside fixed link;
an outside output link; and
a first to a M-th outside active links connected between the outside fixed link and the outside output link via a plurality of joint axles extended along a Z axis direction respectively, the first to the M-th outside active links being configured parallel from a +X side to a −X side, wherein the M refers to an integer which is 2 or more than 2;
wherein the inside parallel link comprises:
an inside fixed link;
an inside output link; and
a first to an N-th inside active links connected between the inside fixed link and the inside output link via a plurality of joint axles extended along the Z axis direction respectively, the first to the N-th inside active links being configured parallel from the +X side to the −X side, wherein the N refers to an integer which is 2 or more than 2;
wherein the outside parallel link is mutually connected with the inside parallel link through the outside output link and the inside fixed link, so that the at least two compound links are configured opposite to each other on a +Y side and on a −Y side relative to the inside output link.

2. The bearing mechanism for a movable body of claim 1, wherein, in the at least two compound links, an outward normal line of a plane formed by joint axles configured on the two sides of the first outside active link tilts by an acute angle from the +X axis to any of the +Y side and the −Y side, and an outward normal line of a plane formed by joint axles configured on the two sides of the first inside active link tilts by an acute angle from the +X axis to the other of the +Y side and the −Y side.

3. The bearing mechanism of a movable body of claim 1, wherein the outside output link configured at the +Y side, a restricted link, and the outside output link configured at the −Y side are serially connected with one another through a plurality of joint axles prolonged along the Z axis direction.

4. The bearing mechanism of a movable body of claim 2, wherein the outside output link configured at the +Y side, a restricted link, and the outside output link configured at the −Y side are serially connected with one another through a plurality of joint axles prolonged along the Z axis direction.
